(19) United States
(12) Patent Application Publication
(10) Pub. No.: US 2014/0097590 A1
(43) Pub. Date: Apr. 10, 2014

(54) REINFORCEMENT OF SHOCK ABSORBER MOUNT

(71) Applicant: HYUNDAI MOTOR COMPANY, Seoul (KR)

(72) Inventors: Young Dae Yoo, Yongin-si (KR); Do Hoi Kim, Hwaseong-si (KR)

(73) Assignee: Hyundai Motor Company, Seoul (KR)

(21) Appl. No.: 13/707,267

(22) Filed: Dec. 6, 2012

(30) Foreign Application Priority Data
Oct. 9, 2012 (KR) 10-2012-0111593

(51) Int. Cl. B60G 15/00

(52) U.S. Cl. CPC B60G 15/00
USPC 280/124.155

(57) ABSTRACT

A reinforcement is installed in a mounting portion of a shock absorber of a vehicle to improve strength of a vehicle body. The reinforcement realizes a new type of a reinforcement which covers a mounting portion affected most by an excitation force from a shock absorber and is simultaneously coupled to a mounting cover, which is a peripheral member, and a front side upper member, such that road noise can be improved by improvement of Z-direction input point strength. (vehicle body strength) of a shock absorber housing portion.

### CROSS-REFERENCE TO RELATED APPLICATION

The present application claims priority of Korean Patent Application Number 10-2012-0111593 filed Oct. 9, 2012, the entire contents of which application is incorporated herein for all purposes by this reference.

### BACKGROUND OF INVENTION

1. Field of Invention

The present disclosure relates to a reinforcement which is installed on a shock absorber mount of a vehicle to improve the strength of a vehicle body.

2. Description of Related Art

Generally, a suspension device of a vehicle absorbs vibration from the road and buffs a shock applied to various parts to secure comfortableness in the vehicle, prevent vehicle pulling in turning of the vehicle, and maintain the balance of the vehicle.

Such a suspension device includes an upper arm and a lower arm coupled to upper sides and lower sides of knuckles mounted on vehicle wheels, a chassis spring for alleviating a shock from the road during driving, a shock absorber for improving comfortableness by suppressing vehicle body's up/down vibration, a stabilizer for maintaining turning stability in turning of the vehicle, and so forth.

Herein, the shock absorber blocks or absorbs vibration generated between the road and the wheels during driving through a bumper rubber and a damper spring to prevent the vibration generated during driving from being transferred to the vehicle body.

For example, a front shock absorber and a rear shock absorber are coupled to the vehicle body in left and right sides of a front portion and a rear portion of the vehicle, respectively, to absorb natural vibration generated by a shock exerted to the spring during driving of the vehicle, thus improving stability and comfortableness of the vehicle, and they are also installed between the suspension device and the vehicle body to reduce fatigue of the spring.

A general shock absorber of a vehicle is coupled on its upper side with an upper mount to be connected to the vehicle body, and through the upper mount, the shock absorber is coupled to the vehicle body by a plurality of bolts.

FIG. 1 shows pictures of a conventional mounting portion of a one-point mounting front shock absorber.

As shown in FIG. 1, in the conventional shock absorber mounting portion, a cowl covers the mounting portion and a separate reinforcement is not used. For a small-size vehicle, one-point mounting is mainly used.

However, the conventional shock absorber mounting portion needs to be improved because it is vulnerable to road noise due to its low Z direction Mounting Portion dynamic stiffness. For example, Z-direction input point strengths are 800 kgf/mm for (1), 1000 kgf/mm for (2), 1000 kgf/mm for (3), and 840 kgf/mm for (4), such that they all are low.

To meet such a need, a cover and an inner reinforcement may be used inside a top cover and their thicknesses are made thick to improve intake point strength, or a cowl may cover a mounting cover to distribute a force of H and L planes, but such schemes are unfavorable in terms of structure or weight and are still unsatisfactory in terms of reinforcement of intake point strength in up/down directions.

A Japanese Patent Application Publication No. 1989-036582 discloses a suspension tower reinforcement structure for a vehicle, in which a wheel apron reinforcement material and a reinforcement member which are linked to a front frame near a protrusion portion of a wheel apron are provided in the exterior of the vehicle body, thereby achieving accurate wheel alignment and distributing loads, but this structure is also unsatisfactory in terms of Z-direction intake point strength.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made to solve the foregoing problem, and provides a reinforcement of a shock absorber mounting portion, which realizes a new type of a reinforcement which covers a mounting portion affected most by an excitation force from a shock absorber and is simultaneously coupled to a mounting cover, which is a peripheral member, and a front side upper member, such that road noise can be improved by improvement of Z-direction input point strength (vehicle body strength) of a shock absorber housing portion.

The reinforcement is installed in a mounting portion in which a top end portion of the shock absorber is engaged, and is engaged with a mounting cover and a front side upper member while covering a circumference of a protrusion portion, thus distributing a force introduced to the mounting portion to the mounting cover and the front side upper member.

Therefore, the reinforcement is installed in the mounting portion most affected by an excitation force generated by the shock absorber to distribute a force introduced to the mounting portion to peripheral members, thus improving vehicle body strength.

Herein, the reinforcement may include a body portion in the shape of a ring, which has a wall portion set up along an inner circumference, and a plurality of bridge portions disposed along an outer circumference of the body portion and extending by a predetermined length. In particular, the plurality of bridge portions may include three bridge portions disposed at 120° intervals for balanced force distribution.

At least two of the plurality of bridge portions of the reinforcement may be bent downwardly to be fixed while covering a sidewall of the mounting cover.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 shows pictures of a conventional mounting portion of a one-point mounting front shock absorber.

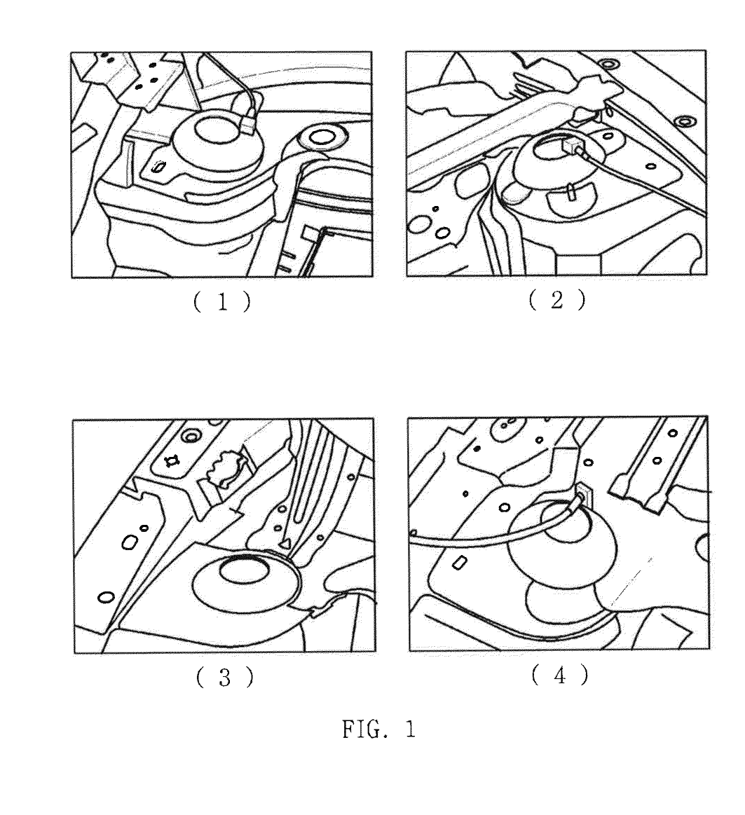

FIG. 2 is a plane view showing a portion in which an exemplary reinforcement is installed according to the present invention.

FIG. 3 is a perspective view of an exemplary reinforcement according to the present invention.

FIG. 4 is a perspective view of a state in which an exemplary reinforcement is installed according to the present invention.

FIG. 5 is a simulation picture showing a result of vibration absorption of an exemplary reinforcement according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

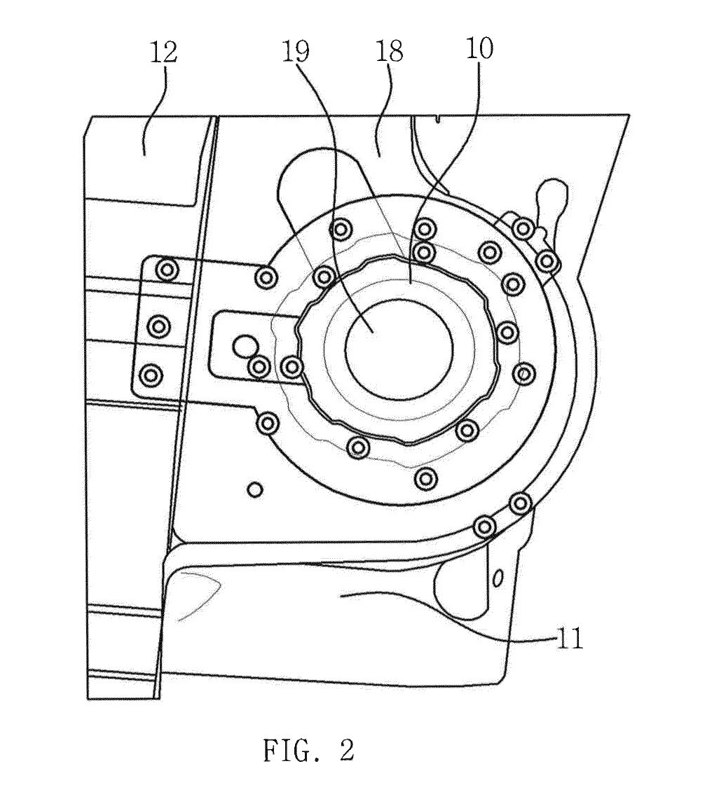

FIG. 2 is a plane view showing a portion in which a reinforcement is installed according to various embodiments of the present invention.

As shown in FIG. 2, a mounting cover 11 is disposed at a. side of a front side upper member 12, and a cover bracket 18 is installed overlappingly on a top surface portion of the mounting cover 11, that is, on a top surface portion of a portion in which a top end portion of a shock absorber is mounted. In the mounting cover 11 and the cover bracket 18 is formed a protrusion portion 10 with a hole 19 in the center thereof, which is the portion in which the shock absorber top end portion is mounted.

In this structure, a portion surrounding (and including) the protrusion portion 10 is a portion in which the shock absorber is supported, that is, mounted.

Herein, to absorb vibration caused by an excitation force generated by the shock absorber, the mounting intake point strength (in the unit of kgf/mm) of the protrusion portion 10 and a portion surrounding the protrusion portion 10 is very important.

In a conventional vehicle structure, the intake point strength of a mounting portion including a protrusion portion is overall lower than a predetermined level, and especially, a Z-direction intake point strength level of the mounting portion is insufficient.

Therefore, to solve this problem, the present invention provides a reinforcement 13 in the form of a tripod, which covers a mounting portion affected most by an excitation force generated by a shock absorber, that is, the mounting portion surrounding and including the protrusion portion 10 and is simultaneously engaged with peripheral members such as the front side upper member 12 and the mounting cover 11.

As the top end mounting portion of the shock absorber is reinforced with the reinforcement 13 in the form of a tripod, a force introduced into the mounting portion may be distributed to the front side upper member 12, thereby achieving strength improvement (vibration absorption).

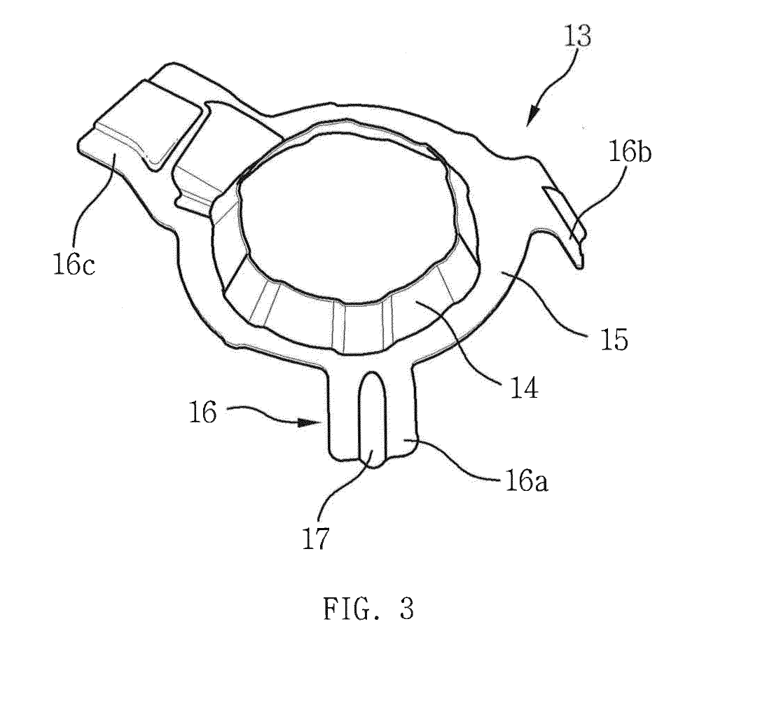

FIG. 3 is a perspective view of the reinforcement 13 according to various embodiments of the present invention.

As shown in FIG. 3, the reinforcement 13 is installed in the mounting portion. engaged with the top end portion of the shock absorber, and includes a body portion 15 having a ring shape and a plurality of bridge portions 16 having long belt shapes of a predetermined length and a predetermined width, in which the body portion 15 and the plurality of bridge portions 16 are formed integrally with each other. One will appreciate that the body and bridge portions may be monolithically formed.

In particular, a wall portion 14 set up to a predetermined height in an inclined posture is formed integrally along an inner circumference of the body portion 15, and the wall portion 14 covers the protrusion portion of the mounting cover 11, substantially, the circumference of the protrusion portion 10 of the cover bracket 18 which covers the protrusion portion of the mounting cover 11, in a closely contact manner. One will appreciate that the wall and body portions may be monolithically formed.

The bridge portions 16 are disposed along the outer circumference of the body portion 15 and extend by a predetermined length, and for example, the bridge portions 16 include three bridge portions 16a, 16b, and 16c disposed at 120° intervals, among which two bridge portions 16a and 16b are downwardly bent to cover the sidewall of the mounting cover 11.

Herein, the remaining one bridge portion 16c except for the two bridge portions 16a and 16b which cover the sidewall of the mounting cover 11. among the three bridge portions 16a, 16b, and 16c extends towards the front side upper member 13 to cover a top surface of the front side upper member 13.

Beads 17 for strength improvement are formed in the bridge portion 16 of the reinforcement 13, and the beads 17 may extend in parallel with the longitudinal direction of the bridge portion 16.

The bead 17 may also be provided in the wall portion 14 of the body portion 15 as well as in the bridge portion 16.

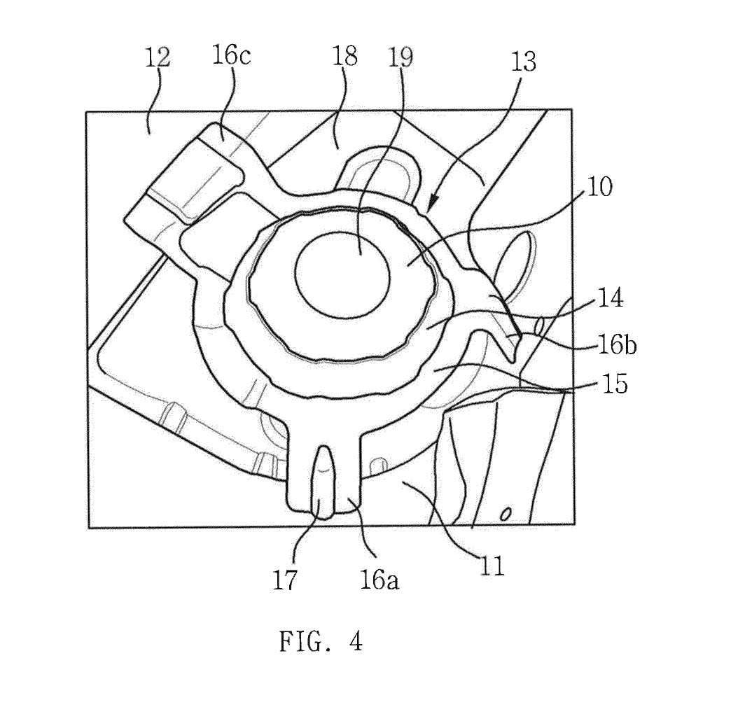

FIG. 4 is a perspective view of a state in Which the reinforcement 13 is installed according to various embodiments of the present invention.

As shown in FIG. 4, the reinforcement 13 is installed such that it covers the circumference portion of the protrusion portion 10 in the mounting cover 11 and the cover bracket 18 and at the same time, is engaged to the mounting cover 11 and the front side upper member 12 by means of welding or a bolt.

For example, if the reinforcement 13 is put on the mounting cover 11 in a state where the center of the body portion 15 having the ring shape is matched to the center of the hole 19 of the protrusion portion 10, then the wall portion 14 of the body portion 15 encloses the lower end circumference of the protrusion portion 10, and at the same time, the body portion 15 covers the surrounding portion of the protrusion portion 10, and the three bridge portions 16a, 16b, and 16c cover and span the mounting cover 11 and the front side upper member 12.

That is, the two bridge portions 16a and 16b closely contact the sidewall of the mounting cover 11, and the one bridge portion 16c covers the top surface of the front side upper member 15 in a closely contact manner.

Therefore, a force introduced into the mounting portion due to an excitation force of the shock absorber is distributed by being transferred to the mounting cover 11 and the front side upper member 15 through the three bridge portions, such that the excitation force of the shock absorber can be effectively distributed and absorbed, and thus road noise can be improved through intake point strength improvement.

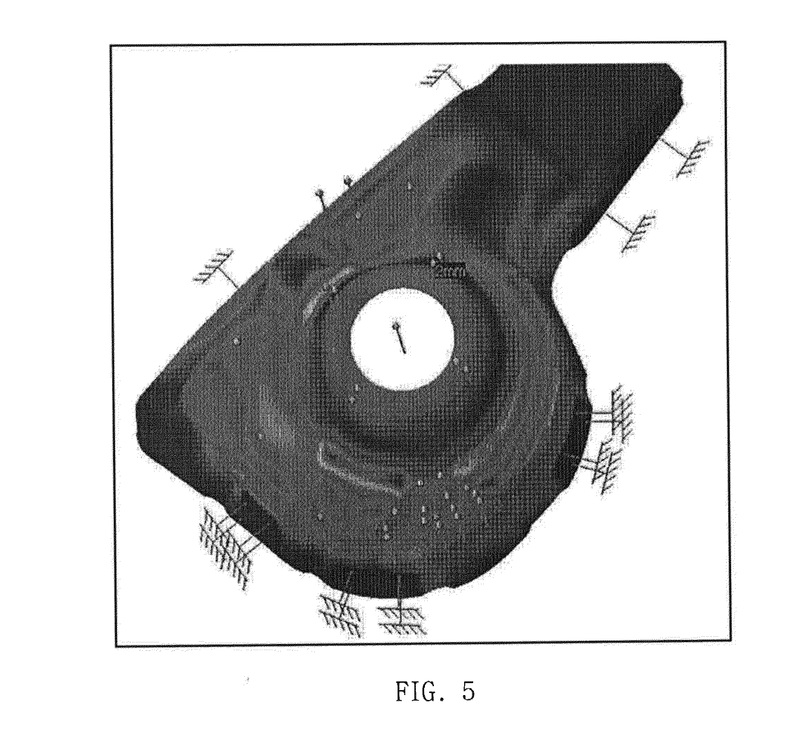

FIG. 5 is a simulation picture showing a result of vibration absorption of the reinforcement 13 according to various embodiments of the present invention, in which vibration transferred through the mounting portion is distributed to peripheral members due to the reinforcement 13, as expressed in green.

As such, the excitation force caused by the road during driving is mostly transferred to the shock absorber and that excitation force is transferred to the mounting portion which supports the top end portion of the shock absorber, and thus triggers vibration.

In this case, as in the present invention, by using the reinforcement 13 capable of distributing the generated vibration to a portion surrounding the mounting portion, Attachment point dynamic stiffness is raised, leading to positive effects in NVH performance.

By firmly engaging a portion in which stress is concentrated and largest deformation occurs with peripheral members, vibration energy can be effectively distributed and Attachment point dynamic stiffness can be raised through absorption of most of the excitation three.

Conventional reinforcements stand a force of an H plane, but the reinforcement 13 according to the present invention endures forces of H and L planes, thereby increasing intake point strength along Y and Z axes.

In the present invention, for the reinforcement, a 120° interval, which is most stable in a tripod structure, is used to uniformly distribute the three, and by adding a bead to the reinforcement in the form of a tripod, strength can be improved.

The reinforcement of the mounting portion of the shock absorber according to the present invention has advantages described below.

To absorb vibration caused by the excitation force generated by the shock absorber, the reinforcement in the form of a tripod is installed in the mounting portion affected most by the excitation force generated by the shock absorber, such that the force introduced into the mounting portion can be distributed to the peripheral members, e.g., the front side upper member, the mounting cover, and so forth, thereby achieving strength improvement (vibration absorption) in the mounting portion and thus improving road noise based on vehicle body strength reinforcement.

For convenience in explanation and accurate definition in the appended claims, the terms upper or lower, front, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A reinforcement for a shock absorber mount, wherein the reinforcement is installed on a mounting portion to which a top end portion of a shock absorber is engaged, wherein the reinforcement is engaged with a mounting cover and a front side upper member while covering a circumference of a protrusion portion, thus distributing a force introduced to the mounting portion to the mounting cover and the front side upper member.

2. The reinforcement of claim 1, comprising:
a body portion in the shape of a ring, which has a wall portion set up along an inner circumference; and
a plurality of bridge portions disposed along an outer circumference of the body portion and extending by a predetermined length.

3. The reinforcement of claim 1, wherein three bridge portions disposed at 120° intervals for balanced force distribution.

4. The reinforcement of claim 2, wherein the plurality of bridge portions comprise three bridge portions disposed at 120° intervals for balanced force distribution.

5. The reinforcement of claim 4, wherein at least two of the plurality of bridge portions of the reinforcement are bent downwardly to cover a sidewall of the mounting cover.

6. The reinforcement of claim 1, wherein a bead for strength improvement is formed in at least one of the bridge portions of the reinforcement.

7. The reinforcement of claim 2, wherein a bead for strength improvement is formed in at least one of the bridge portions of the reinforcement.
